(19) United States
(12) Patent Application Publication
(10) Pub. No.: US 2026/0008925 A1
(43) Pub. Date: Jan. 8, 2026

(54) MERCAPTIDE MICROEMULSIONS

(71) Applicant: Arkema Inc., King of Prussia, PA (US)

(72) Inventors: Carlos F. BUITRAGO, King of Prussia, PA (US); Andrew POLLI, King of Prussia, PA (US); Lijuan WANG, King of Prussia, PA (US)

(21) Appl. No.: 18/879,956

(22) PCT Filed: Mar. 23, 2023
(86) PCT No.: PCT/US2023/015996

§ 371 Date: Dec. 30, 2024

Related U.S. Application Data
(60) Provisional application No. 63/357,019, filed on Jun. 30, 2022.

(51) Int. Cl. C09D 5/02; B03D 1/012; C08G 75/14; C08K 5/37; C09D 7/45; C09D 7/61; C09D 7/63; C09D 7/65; C09D 15/00; C09D 181/04

(52) U.S. Cl. CPC C09D 5/022; B03D 1/012; C08G 75/14; C09D 5/027; C09D 7/45; C09D 7/61; C09D 7/63; C09D 7/65; C09D 15/00; C09D 181/04; B03D 2201/02; C08K 5/37

(57) ABSTRACT

The present invention provides mercaptide microemulsions and methods for forming mercaptide microemulsions.

### FIELD OF THE INVENTION

The invention relates to novel mercaptide microemulsions.

### BACKGROUND OF THE INVENTION

The present invention relates generally to a new composition comprising mercaptide microemulsions.

Heavy mercaptans have unique chemical properties that make them especially useful in applications such as mineral recovery, metal protection, surface modification, polymer functionalization, among others. However, heavy mercaptans also exhibit a strong odor and immiscibility with water which limit their use in many applications.

### SUMMARY OF THE INVENTION

In accordance with this invention it has been found that mercaptide microemulsions can be used in place of mercaptans in many applications while minimizing the odor exhibited by mercaptans. An object of the present invention is to reduce the perceived odor of heavy mercaptans (liquids) by transforming the thiol group into an ionic thiolate. The resulting heavy mercaptide salts (solids) also attain an improved compatibility with water, allowing for the preparation of water-based formulations with unique microstructures (microemulsions). The formation of the mercaptide microemulsions can occur in one vessel by combining the components which can include thiolates, water, alcohols, surfactants and dispersing agents. These water-based mercaptide microemulsions are a new product form of heavy mercaptans in which the perceived odor is lower and the activity of these molecules improves due to the increased interfacial area typical of microstructures.

### BRIEF DESCRIPTION OF THE FIGURES

FIG. 1 shows a mercaptide microemulsion following an embodiment on the present invention (Sample 5 on the left) and a prior art mercaptan emulsion (Sample 8 on the right).

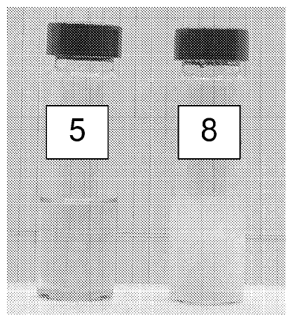

### DETAILED DESCRIPTION OF CERTAIN EMBODIMENTS OF THE INVENTION

“Microemulsion” means a dispersion comprising a continuous phase material, substantially uniformly dispersed within which are droplets of a dispersed phase material, the droplets are sized in the range of approximately from 1 to 100 nm, usually 10 to 50 nm.

In at least one embodiment a microemulsion is provided comprising a continuous phase material, dispersed within which are droplets of a dispersed phase material. The droplets are sized in the range of approximately from about 1 to about 100 nm, usually about 10 to about 50 nm. Because of the extremely small size of the droplets, a microemulsion is optically clear, isotropic and thermodynamically stable. In at least one embodiment the continuous phase material comprises water. In at least one embodiment the dispersed phase material and/or the continuous phase material comprise one or more hydrophobic materials. In at least one embodiment, the dispersed phase material and/or the continuous phase material comprise amphiphilic and/or ionic materials.

Mercaptans (also known as thiols) may be in the liquid form at standard environmental temperature and pressure comprising a hydrocarbon chain composed of eight to twelve carbon atoms. Such liquid mercaptans are immiscible with water. In addition, these liquids are volatile enough to raise concerns associated to noxious odor, which limits the use of these substances in many applications, particularly those carried out in open vessels. In the present invention, liquid thiols are treated with strong organic or inorganic base(s) to produce mercaptides (ionic salts of mercaptans). In one embodiment, the mercaptides are produced as pure products, solid powders which have improved compatibility with water and do not present the odor concerns associated with thiol volatility. In a further embodiment in accordance with the present invention, the formation of the mercaptides can be accomplished in the presence of other components such as water, alcohols, hydrocarbons, surfactants and/or dispersing agents. Preparation of the mercaptides in such multicomponent liquid systems gives rise to formulations featuring unique microstructures. A preparation embodiment of the present invention for the mercaptide microemulsions may be a one-pot methodology.

The alcohol can be selected from the following group, including isomers thereof: ethanol, propanol, butanol, pentanol, hexanol, heptanol, octanol, cresylic acid and any combination thereof.

The hydrocarbon can be selected from the group pentane, hexane, heptane, octane, nonane, decane, dodecane, propylene tetramer, kerosene, diesel fuel, biodiesel (methyl ester fatty acids) and any combination thereof.

The surfactant can be selected from the group ethoxylated mercaptans, alkylphenol ethoxylates, aklylbenzene sulfonates, poloxamers (Pluronic), polysorbates and any combination thereof.

The dispersing agent can be selected from the group polyethylene glycol, polypropylene glycol, polyglycol ethers and/or other polyols.

Although formation of the mercaptide microemulsions via a one-pot method is preferred, the mercaptide salts derived from mercaptans may also be in the form of a solid after reaction with the base only. The solid mercaptides salts can be used to make microemulsions by mixing them with the liquid components. The mercaptides may also be commercialized in the solid form to be combined with the liquid components to form the mercaptide microemulsion of the present invention.

It was discovered that solids crash out of the microemulsions liquid during extensive manipulation. By subjecting duplicate samples to different post-reaction treatments, it was discovered that mercaptides in the microemulsions can oxidize to disulfides in the presence of oxygen. Thus, for stability it is desirable to minimize or avoid oxidation of mercaptide ions to disulfides.

Heavy mercaptans are thiols (—SH) with hydrocarbon chains between 4 and 18 carbon atoms, typically from about 8 to 15 carbon atoms. The hydrocarbon chains can be straight, branched or cyclical. The mercaptides may originate from mercaptans (molecules containing one thiol group only) or from dithiols or polythiols (two or more thiol groups per molecule). The mercaptans used to form the mercaptides of the present invention can be primary mercaptans, secondary or tertiary mercaptans, having 8-15 carbon atoms. Exemplary dithiols and polythiols, respectively include 1,8-dimercaptan-3,6-dioxaoctane and pentaerythritol tetra (3-mercaptopropinate). When these molecules are subjected to pH values greater than or equal to about 11, the conjugate base mercaptides forms, transforming the —SH group into the ionic S-M+, where M+ is an organic or inorganic cation from a strong base. For example, alkali metal or alkaline earth metal hydroxide bases such as sodium hydroxide, potassium hydroxide, rubidium hydroxide, magnesium hydroxide, calcium hydroxide, lithium hydroxide, barium hydroxide and magnesium hydroxide, or organic bases such as ammonium hydroxide, tetramethylguanidine (which forms the guanidinium cation), guanidine or tetramethylammonium hydroxide will form the conjugate mercaptide when contacted with a mercaptan

Heavy mercaptide salts are free flowing solids in their pure form. In accordance with one embodiment of the present invention, a one pot methodology was discovered in which mercaptides are produced but also act as a major component in the formulation of water-based microemulsions. The microemulsion formulations can comprise the mercaptides, water, and optionally alcohols, hydrocarbons, glycols, polyglycols, surfactants, and/or excess amounts of mercaptan and base from the mercaptide conversion.

The mercaptide-based microemulsion of the present invention can be formed by mixing the components in a single vessel, followed by agitation (stir bar, overhead stirrer, vortex mixer, static mixer or high-shear mixer) until a homogeneous liquid composition is reached. These formulations may initially be murky, but will give rise to the clear microemulsions after a few minutes of settling. The components can be added to the vessel sequentially or all at once. As an alternative, while agitation is a known way of quickly obtaining homogeneous liquid formulations, it is also possible that the components of this invention (in any order) be added to a container, and allowed to react without agitation to obtain a thermodynamically-stable microemulsion as a result of Brownian motion and entropy.

Certain mercaptide powders alone have moderate affinity for water, giving rise to homogeneous liquid products without the need for other components. For example, a mercaptide salt of N-dodecyl mercaptan can form a homogeneous mixture in water in concentrations up to about 2 wt % (from 0.00001 to 2 wt %). With the addition of the liquid components, microemulsions form that may contain as much as 60 wt % mercaptide. A preferred range is between about 0.01 and about 40 wt % mercaptide. Water content can range from about 20 to about 98.0 wt % (as diluent of pure mercaptide powders) preferably from about 40 to about 98 wt % for multicomponent microemulsions. Alcohols can be added between about 2 and about 30 wt %. A preferred range for the alcohols is between about 5 and about 20 wt %. Surfactants may be added between 0 and about 10 wt %. Dispersing agents may be added between 0 and about 20 wt %, more preferably between 5 and 15 wt %. Formation of mercaptides may be accomplished by reacting thiols with equivalent moles of base, although as much as about 1 to about 5 wt % excess base can be used.

The mercaptide microemulsions of the present invention can find use in applications including collectors in mineral ore forth floatation, the formation of self-assembled monolayers (SAM) for surface modification and protection of metals and lignocellulosic materials, antioxidants in the processing and end-use of polyolefin polymers, the formation of larger sulfide and/or polysulfide structures and the stability of nano-scale inorganic structures such as nanoparticles and quantum dots.

### Example 1

Table 1 lists compositions used in the formation of mercaptide microemulsions in accordance with the present invention. The components in the table are: N-dodecyl mercaptan (NDDM), N-decyl mercaptan (NDM), N-octyl mercaptan (NOM), sodium hydroxide (NaOH), potassium hydroxide (KOH), methyl isobutyl carbinol (MIBC), polypropylene glycol (PPG) and polyethylene glycol (PEG). The mercaptide microemulsions were formed by blending the indicated components in any order, at room temperature and with simple agitation. The same mercaptide microemulsions can be produced by blending the components with a high-shear mixer.

TABLE 1

| Component | Sample No. | | | | | | |
|---|---|---|---|---|---|---|---|
| (wt %) | 1 | 2 | 3 | 4 | 5 | 6 | 7 |
| Water | 50.2 | 46.0 | 47.3 | 49.0 | 50.5 | 50.2 | 55.9 |
| NDDM | 18.0 | 18.0 | 0 | 0 | 180 | 18.0 | 18.0 |
| NDM | 0 | 0 | 0 | 18.0 | 0 | 0 | 0 |
| NOM | 0 | 0 | 18.0 | 0 | 0 | 0 | 0 |
| 50% NaOH | 7.5 | 0 | 10.4 | 8.7 | 7.2 | 7.5 | 7.5 |
| in water | | | | | | | |
| 45% KOH | 0 | 11.7 | 0 | 0 | 0 | 0 | 0 |
| in water | | | | | | | |
| MIBC | 18.6 | 18.6 | 18.6 | 18.6 | 18.6 | 18.6 | 18.6 |
| PPG | 5.7 | 5.7 | 5.7 | 5.7 | 5.7 | 0 | 0 |
| PEG | 0 | 0 | 0 | 0 | 0 | 5.7 | 0 |
| Sample | NDDM as | KOH | NOM as | NDM as | 1% | with | without |
| Feature | mercaptan, | as | mercaptan | mercaptan | excess | PEG | dispersing |
| | 5% | base | | | base | | agent |
| | excess | | | | | | |
| | base | | | | | | |

For the samples listed in Table 1, conversion of mercaptans to mercaptides was demonstrated by pH measurements (mercaptides are strong bases, pH of microemulsions containing mercaptides was measured at over 13), UV-Vis spectroscopy (typical mercaptide anion absorption between 240-260 nm detected), and ¹H- & ¹³C-NMR (different chemical shifts detected for mercaptide vs. mercaptan molecules).

The sub-micron structures of these samples was determined by droplet size measurements via dynamic light scattering (DLS), indicating the formation of droplets below 100 nm. The Z-average diameters of Samples 1, 2 and 6 are shown in Table 2.

TABLE 2

| | Z-Average Diameter (NM) |
|---|---|
| Sample 1 | 24 |
| Sample 2 | 13 |
| Sample 6 | 25 |

The one-pot methodology produced mercaptide microemulsions as evidenced by the presence of mercaptides instead of mercaptans in the final product, along with the formation of quantifiable, finely divided and well-dispersed microstructures.

Table 3 lists a composition used in the formation of a mercaptan o/w emulsion obtained by high-shear mixing with the components indicated. Sample 8 did not form a microemulsion. The droplet size of sample 8 could not be measured using DLS because the bubbles were too large for the instrument. A view of Sample 8 by optical microscopy, showed an average particle size for Sample 8 of about 20 microns, well above the microemulsion level. A view of Sample 5 by optical microscopy, showed an visible droplets.

### Example 2 Comparative

TABLE 3

| | Sample No. |
|---|---|
| Component (wt %) | 8 |
| Water | 57.7 |
| NDDM | 18.0 |
| NDM | 0 |
| NOM | 0 |
| 50% NaOH in water | 0 |
| 45% KOH in water | 0 |
| MIBC | 18.6 |
| PPG | 5.7 |
| PEG | 0 |
| Sample ID | No base, not |
| | microemulsion |

The invention claimed is:

1. A mercaptide microemulsion comprising an aqueous continuous phase and a mercaptide dispersed phase having a droplets size from about 1 to about 100 nm.

2. The mercaptide microemulsion of claim 13 in which the droplets size from about 10 to about 50 nm

3. The mercaptide microemulsion of claim 1 in which the continuous phase is water.

4. The mercaptide microemulsion of claim 1 in which the mercaptide is selected from the group consisting of mercaptides, dimercaptides, polymercaptides and any combination thereof.

5. The mercaptide microemulsion of claim 1 wherein the mercaptide is selected from the group consisting of straight chain, branched chain or cyclical primary C8 to C15 mercaptide, straight chain, branched chain or cyclical secondary C8 to C15 mercaptide, straight chain, branched chain or cyclical tertiary C8 to C15 mercaptide and any combination thereof.

6. The mercaptide microemulsion of claim 1 further comprising at least one item selected from the group consisting of surfactants, alcohols, hydrocarbons, dispersing agents and any combination thereof.

7. The mercaptide microemulsion of claim 1 in which the microemulsion further comprises a surfactant along with at least one co-surfactant.

8. The mercaptide microemulsion of claim 6, wherein the surfactant is selected from the group ethoxylated mercaptans, alkylphenol ethoxylates, aklylbenzene sulfonates, poloxamers, polysorbates and any combination thereof.

9. The mercaptide microemulsion of claim 6, wherein the alcohol is selected from the group of ethanol, propanol, butanol, pentanol, hexanol, heptanol, octanol, cresylic acid and any isomers and combination thereof.

10. The mercaptide microemulsion of claim 6, wherein the hydrocarbon is selected from the group pentane, hexane, heptane, octane, decane, dodecane, propylene tetramer, kerosene, diesel fuel, biodiesel (methylated fatty acids) and any combination thereof.

11. The mercaptide microemulsion of claim 6, wherein the dispersing agent is selected from the group polyethylene glycol, polypropylene glycol, polyglycol ethers, polyols and any combination thereof.

12. The mercaptide microemulsion of claim 1 formed by contacting a mercaptan with a base in an aqueous carrier fluid optionally followed by mixing.

13. The mercaptide microemulsion of claim 12 wherein the base is an alkali metal or an alkaline earth metal base.

14. The mercaptide microemulsion of claim 13 wherein the alkali metal or alkaline earth metal base is selected from the group consisting of sodium hydroxide, potassium hydroxide, rubidium hydroxide, magnesium hydroxide, calcium hydroxide, lithium hydroxide, barium hydroxide and magnesium hydroxide, and any combination thereof.

15. The mercaptide microemulsion of claim 12, wherein the base is an organic base.

16. The mercaptide microemulsion of claim 15 wherein the organic metal base is selected from the group consisting of ammonium hydroxide, tetramethylguanidine, guanidine or tetramethylammonium hydroxide and any combination thereof.
